(19) United States
(12) Patent Application Publication
(10) Pub. No.: US 2001/0017632 A1
(43) Pub. Date: Aug. 30, 2001

(54) Method for computer operation by an intelligent, user adaptive interface

(76) Inventor: Dina Goren-Bar, Rishon Le Zion (IL)

Correspondence Address: Altera Law Group, 6500 City West Parkway - Suite 100, Minneapolis,, MN, 55344-7701, US

(21) Appl. No.: 09/778,398

(22) Filed: Feb. 2, 2001

Related U.S. Application Data
(63) Continuation of application No. PCT/IL99/00432, filed on Aug. 5, 1999.

(30) Foreign Application Priority Data
Aug. 5, 1999 (IL) 125684

(51) Int. Cl. G06F 3/00

(52) U.S. Cl. 345/744; 345/705

(57) ABSTRACT

Method for interactive, user adaptive operation of a computerized system by using an intelligent user interface. Information about the user and his tasks is collected and stored. A preliminary dynamic stereotype user model is built, based on predetermined default values and/or on the information about the user, as well as a task model for the user. A preliminary adaptation level of the interface is provided to the user and the user task is characterized by adaptation between the user task and the user. After a predetermined period with no user operation, assistance is offered to the user. Requests from the user are received and if found correct, executed by operation an adaptive dialog manager for the specific user. If found incorrect, instructions/help is provided to the user by the adaptive dialog manager. A user protocol representing the information about the user, collected during his operation, is generated and/or processed. Macros and/or batch automated files, representing the user's modes of operation by a sequence of operations typical for the user, are generated and/or updated. The preliminary user model, the user tasks and the user characteristics are updated in a manner responsive to the processed information from the user protocol and to successes/failures during operation of the user observed by the dialog manager. In case when a conflict between characteristics resulting from the collected information the stereotype user model occurs, the user characteristics are updated. The preliminary adaptation level of the dialog manager is modified and interaction with the user is carried out through the dialog manager according to the updated user model, user tasks and user characteristics.

### FIELD OF THE INVENTION

The present invention relates to the field of computer operation. More particularly, the invention relates to an improved method for user operation of computers, by using an intelligent adaptive user interface, responsive to the user operations and competence.

### BACKGROUND OF THE INVENTION

In the recent years, considerable efforts have been devoted to simplify the interaction between the user and the computer operated by the user. Graphical interfaces, e.g., Microsoft Windows, OSF-Motif and others have been exploited by user operating methods, based on the principle of “What You See Is What you Get” (WYSIWYG). These interfaces require less competence and knowledge from the user, but still introduced an equal base-line for any user, regardless his particular level of knowledge.

Some theories about trends of more intelligent methods using interactive interfaces between the user and the operated computer have been proposed. “Mind melding; How Far Can the Human/Computer Interface Go?” to Linderholm, Byte. Vol. 166, No. 11, 1991, p.p. 41-46 proposes computer operation by using interfaces with some degree of common-sense, multi-media, indoor large displays and user voice identification. “User-Interface Developments for the 1990's” to Marcus, Computer, Vol. 24, No. 9, 1991, p.p. 49-58 proposes computer operation by using interfaces with real time animation, means for tracing after the user eye operation and on-line error correction. “A Conversation with Don Norman” to Norman, Interactions, Vol. 2, No. 2, 1995, p.p. 47-55 even goes further by assuming computer operation by using interfaces which may be matching the user tasks enough to eliminate the need for help during operation. Some technological efforts were devoted to such ideas, but still these efforts lack the deep understanding of the user tasks and needs.

Other operating methods provide the user tools to overcome problems which arise during the computer operation. Operating according to these “Tool Centered” methods directs the user to adjust himself to these tools, leading to a problematic mode of operation, where the user faces difficulties to interpret his wills and goals to specific and simple set of instructions to the computer. Operating methods that overcome these drawbacks should be “task oriented”, i.e., adjusting their interface operation to the user needs and operating at the task level instead of the system tools level.

Nowadays, most of the widespread computer operation methods are directed to a diversity of users, each with different level of knowledge. Moreover, since modern computer systems become more and more complex, many users have only partial knowledge about the system functions and/or capabilities. In addition, different users are characterized by different needs as well as different levels of knowledge. Thus, operating methods based on a uniform interface for all users will not be sufficient.

Recently, some efforts has been devoted to try to overcome the described drawbacks. “Human-Computer Interaction” to Dix et al., Prentice-Hall 1991 proposes an operating method using a system that collects data about the user, modeling the user, his tasks and the main subjects related to his work. This information is used, together with smart help, to support the user in a way that is most relevant to his tasks and experience. However, this method is almost not practical, since a huge amount of data, as well as large data-base is required for implementation. Furthermore, interpretation of such data about the level of interaction between the user and the computer is very complicated.

WO 98/03907 to Horvitz et al. discloses an intelligent assistance facility helping the user during his operation. This facility comprises an event composing and monitoring system, which creates high level events from combinations of user actions by collecting visual and speech information about the user. The system uses the information to compute the probability of alternative user's intentions and goals or informational needs and changes the given assistance based on user competence. However, this user assistance facility lacks flexibility in user characterization capabilities and the ability to contest with conflicts. The system also does not consider the user's position with respect his tasks.

All the methods described above have not yet provided adequate solutions to the problem of providing an intelligent, interactive and user adaptive method for user operation, that is based on an intelligent interface, while overcome the described drawbacks. Another problematic aspect concerning these methods is how much active and/or creative should this intelligent interface be, without leading the user into confusion. Another aspect which still remains problematic, is how to contest with different and varying knowledge levels of an individual user operating a complex computerized system.

It is an object of the invention to provide a method for operating computers, while overcome the drawbacks of the prior art.

It is another object of the invention to provide a method for operating computers by using an intelligent and user friendly interface.

It is another object of the invention to provide an interface with simple and easy interaction with the user.

It is another object of the invention to provide a flexible user interface with continuous adaptation to the user.

It is another object of the invention to provide a user interface that collects information and draws inferences about the user.

It is still another object of the invention to provide a user interface which is able to handle data which is in conflict with previous data about the user.

It is yet another object of the invention to provide a flexible user interface which enables addition and modification of the user's characteristics.

Other purposes and advantages of the invention will appear as the description proceeds.

### SUMMARY OF THE INVENTION

The invention is directed to a method for interactive, user adaptive operation of a computerized system by using an intelligent user interface. Information about the user and the user tasks are collected by monitoring the user operations, and stored. Monitoring includes counting the number of times the user requested for help, the number of user errors, the time intervals between consecutive user operations and seeking after user preferences. Preferably, information about the user is collected by a questionnaire or an interview.

Preferably, a preliminary dynamic stereotype user model, based on predetermined default values and/or on the information about the user is built, as well as a task model for the user. Preferably, default values are extracted from pre-programmed assumptions, researches and studies of the addressed population of users.

A preliminary adaptation level of the interface to the user is provided. The user task is characterized by adaptation to the user, based on the collected information and the user model. Preferably, if after a predetermined period there is no user operation, assistance is offered to the user. Requests are received from the user, and executed by operating an adaptive dialog manager for the specific user, in case they are correct requests (successes). On the other hand, if the requests are incorrect (failures), instructions/help is provided by operating an adaptive dialog manager.

Preferably, information about the user, which is collected during his operation, is stored in a user protocol. User macros and/or batch automated files are generated and/or updated according to identified sequences of operations from the protocol, which are typical for the user. The preliminary user model, the user tasks and the user characteristics are updated in response to processed information from the user protocol and to successes/failures during operation of the user observed by the dialog manager. The system provides the user help in case when no task is selected for execution and corrective instructions, due to failure analysis.

In case of conflicts between characteristics resulting from the collected information and the stereotype user model, the user characteristics are updated. The preliminary adaptation is modified, and the dialog manager interacts with the user according to the updated user model, user tasks and user characteristics.

Preferably, the user model is constructed by defining hierarchy of user stereotypes and associating characteristics for each user stereotype, wherein a value,. from a predetermined scale, is assigned for each characteristic. The user preliminary model is characterized by selecting a set of stereotype attributes. The preliminary characterization is updated by modifying/adding user characteristics and/or their values based on observation. Preferably, contradictions between user characteristics are set by obtaining all the user relations to different user stereotypes and characteristics, all the user certain characteristics based on observation, and for each user characteristic with more than one value, selecting only the highest value and its associated stereotype.

Preferably, the task model is constructed by collecting and storing information about the user tasks, needs and functions and interacting with the utilities of the inherent operating system in a manner enabling execution of these utilities by the interface. Inherent utilities comprise editing, printing, reading utilities and connecting utilities to other computer networks. The inherent operating system comprises connecting utilities to other networks, such as a computer network, a web-based network, a telephone network, a cellular network, or a cable TV network.

The lowest task level is determined and each task is decomposed to a set of sub-tasks necessary to accomplish the task. Each sub-task is also decomposed iteratively, until the lowest task level is reached, and the specific sequence of tasks and/or sub-tasks is then defined. As a result, a set of individual tasks and/or jobs is output into the dialog manager.

Preferably, the user protocol is processed by counting and sorting the number of user failures and correct operations for each task, and seeking after user macros during operation and counting the frequency of each macro. The user model is updated updating the user level of knowledge, the user tasks, the user macros and the user characteristics. The user level of knowledge is updated by seeking after new information about the level of knowledge, updating or using the current level of knowledge, or using default parameters as the current level of knowledge. Each user task is updated by adding a task, in case when no task exists.

Each user macro is updated by first seeking after an existing macro. If no macro exists, the frequency of any identified sequence of user operations is counted. For any existing macro, the mean frequency per session and the general frequency of all previous sessions is calculated. A macro is generated from the identified sequence, in case when no existing macro is identified, and the frequency of the sequences is equal to or higher than a predetermined value. The mean frequency per session and the mean frequency of previous sessions is stored for each generated macro.

Preferably, interaction between the user and the dialog manager is carried out by a keyboard with suitable display, soft touch sensors, a microphone and a speaker, a Personal Digital Assistant (PDA), a cellular-phone, or a television (TV) remote-control unit, and suitable display, which may be a monitor, a soft touch display, or an interactive TV set.

The invention is also directed to a computerized system, operated by the described method. The computerized system is not limited to a specific kind, and may be any kind of a PC, a workstation, a mini-computer, a main-frame computer, a client-server system, an INTERNET server, a telemedicine network etc.

### BRIEF DESCRIPTION OF THE DRAWINGS

The above and other characteristics and advantages of the invention will be better understood through the following illustrative and non-imitative detailed description of preferred embodiments thereof with reference to the appended drawings, wherein:

FIG. 1 is a block diagram of a computerized system operated by an intelligent user interface;

FIG. 2A is a flowchart of the operations employed by the invention for the adaptation process of the interface to the user;

FIG. 2B is a flowchart of the operations employed by the invention for the adaptation process of the interface to the user;

FIG. 2C is a flowchart of the operations employed by the invention for the adaptation process of the interface to the user;

FIG. 2D is a flowchart of the operations employed by the invention for the adaptation process of the interface to the user;

FIG. 2E is a flowchart of the operations employed by the invention for the adaptation process of the interface to the user;

FIG. 3A is flow chart of user representation by a preliminary user model;

FIG. 3B is flow chart of user representation by a preliminary user model;

FIG. 4A is a flow chart of an intelligent help process according to the invention;

FIG. 4B is a flow chart of an intelligent help process according to the invention;

FIG. 5 is a flow chart of the process of guiding the user according to the invention;

FIG. 6 is a flow chart of user protocol processing according to the invention;

FIG. 7 is a flowchart of user model updating according to the invention;

FIG. 8 is a flowchart of user macro updating according to the invention;

FIG. 9 is a flowchart of updating of the user's level of knowledge according to the invention;

FIG. 10 is a flowchart of updating of the tasks in the user model, according to the invention;

FIG. 11 is a flowchart of updating of the attributes in the user model, according to the invention;

FIG. 12 is a flowchart of an example of Hierarchical Task Analysis (HTA);

FIG. 13 illustrates screen output displaying the main screen functions used for user modeling according to the invention;

FIG. 14A to 14F illustrate screen outputs displaying each function from the main screen;

FIG. 15A to 15G illustrate screen outputs displaying steps of task modeling according to the invention;

FIG. 16A to 16C illustrate screen outputs displaying steps of adaptation of the interface to a specific user according to the invention.

### DETAILED DESCRIPTION OF PREFERRED EMBODIMENTS

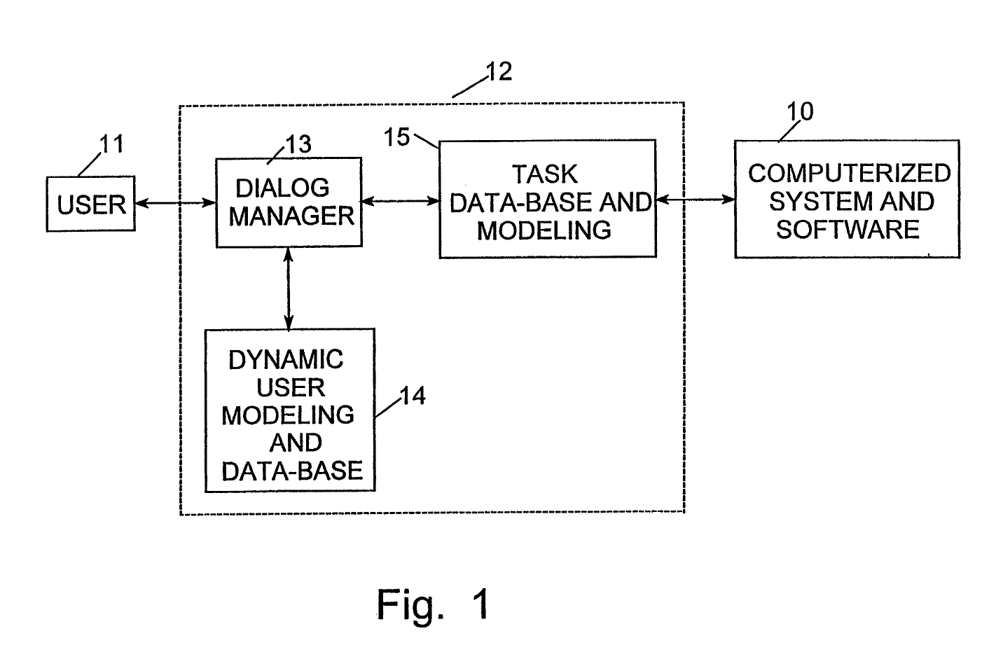

The invention provides the user of a computerized system a novel method for operating the system by interacting with an intelligent user friendly interface with adaptation to the level of competence of any specific user. FIG. 1 is a block diagram of a computerized system 10 comprising hardware and software, which is operated by the user 11 via an intelligent user interface 12. Interface 12 interacts with user 11 by employing a dialog manager 13 which collects instruction and information from the user 11 and tasks he likes to carry out, and in return offers the user 11 help and/or instructions for further operations required to accomplish the user tasks. The dialog manager 13 may interact with the user with a keyboard, soft touch sensors, microphones, speakers, an interactive television (TV) and a visual display which may comprise soft touching icons. Information about the user, which is collected in advance and/or continuously during operation, is stored in a user database 14 and is then exploited by interface 12 to build a dynamic user model which is continuously updated during operation. In addition, information about the user tasks, which is also collected in advance and/or continuously during operation, is stored in a task database 15 and is then exploited by interface 12 to build a task model. Interface 12 communicates with the computerized system 10 which executes the desired user tasks by decomposing and executing each task according to the task model. Interaction with the user is carried out by interface 12 with adaptation to the user's competence and tasks in accordance with information (about the user) extracted from the updated user model and from his task model.

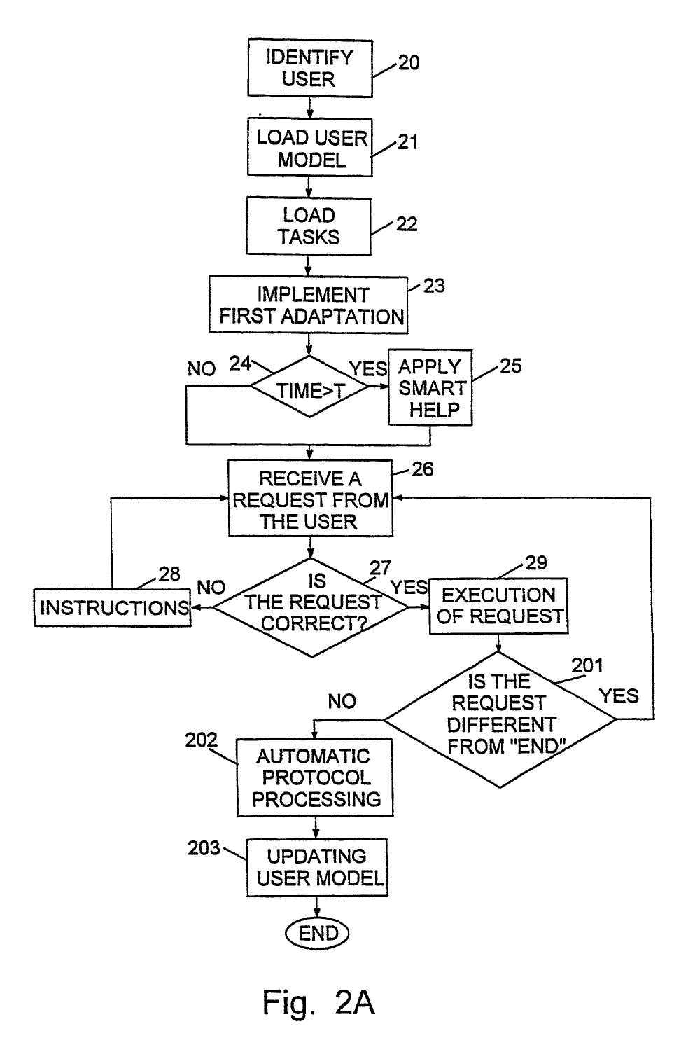

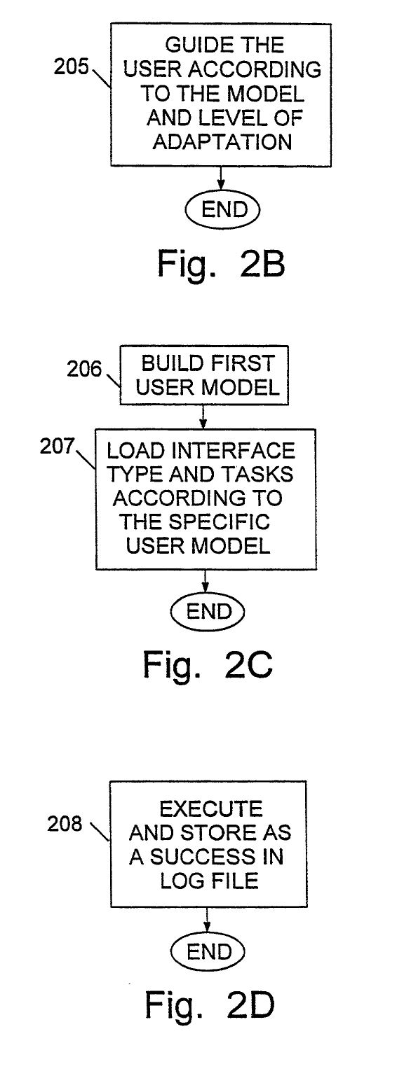

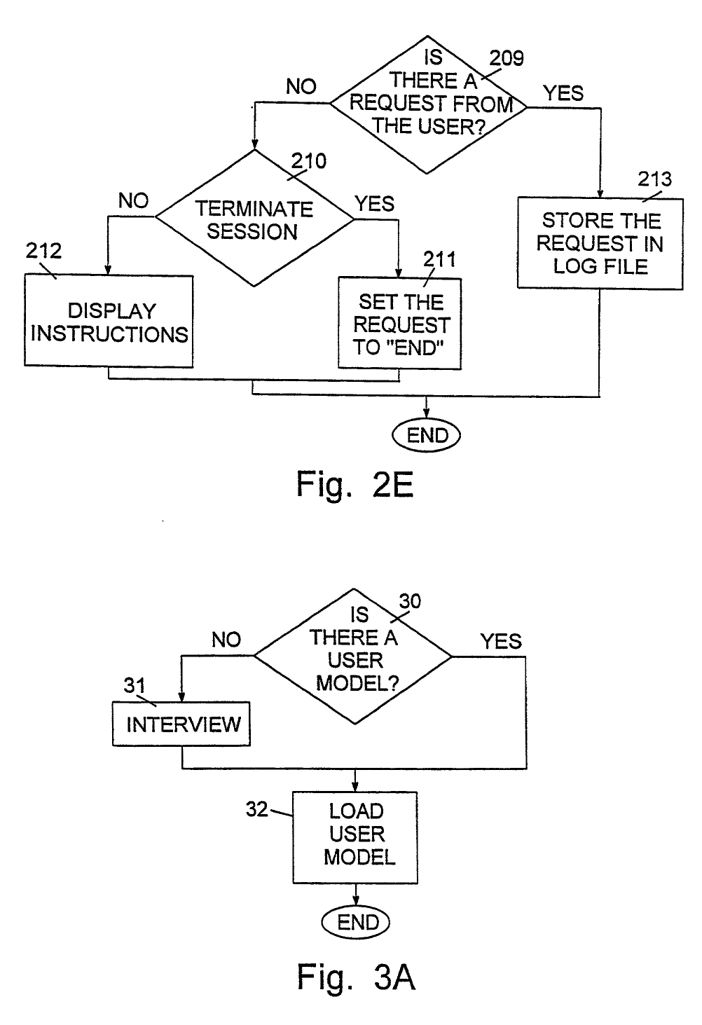

According to the invention, the user is modeled by stereotype model from the collected information. A flowchart of the operations employed by the invention for the adaptation process of the interface to the user is presented in FIG. 2A. The first step 20, is identifying the user by software inputs (user name and/or a password) or by inputs provided by hardware, such as smart cards, bar-codes, sensors, voice recognition devices etc. The next step 21, is loading a preliminary user model. A flow chart of user representation by a preliminary user model is illustrated in FIG. 3A. At the first step 30 the interface checks if there is an existing model of the user. If not, the first interaction is a short interview with the user and building a model in step 31. If there is an existing model, the next step 32 is to load the model into the interface.

During a short interview with the user, questions are introduced to the user by the dialog manager 13 of FIG. 1, so as to collect preliminary information about the user and his tasks. This information comprises user personal details, occupation, position, experience with the software that executes the user tasks, and experience with similar software. In addition, several screens of the software, comprising most of the software functions are introduced and the user is asked to mark on screen the main tasks selected (by him) for execution. The user is also asked to specify the tasks in which he faced difficulties during operation and of what kinds. Information about missing functions/utilities expressed by the user is collected, as well as user preferences, e.g., how the user would like to execute a specific task. If, from any reason, the user refuses to answer to some (or all the) questions, default values or a default are loaded. These default values are extracted from previous researches and/or studies of the addressed population of potential users.

A flowchart of the interview with the user is shown in FIG. 3B. The first step 33, Is seeking after the existing level of knowledge about the user, which may result from previous interview and/or previous session. At the next step 34, the user is asked to supply required (or missing) information. At the next step 35, the user response is checked. If the user refuses to answer or not responding from any reason, a default user model is generated at step 36. In case when the user cooperates, a user model is generated in step 37, according to the provided information.

A preliminary stereotype user model is built and loaded at the second step 21. A hierarchy of user stereotypes is defined to construct user classifications. The user may be associated with one or more stereotypes in any hierarchy level. For instance, a user may be an athlete and an engineer with blue eyes. Each stereotype is associated with different characteristics where each characteristic having a weighted value from a pre-determined scale. According to the invention, this stereotype user model is able to settle contradictions between different characteristics. If there is no preliminary information about several characteristics, pre-programmed stereotype assumptions are provided based on other (known) stereotypes. For example, if the user is a software engineer, a high level of competence in computer operation is assumed. In case of a conflict between characteristics of different hierarchy levels, the characteristic having the lower level in the hierarchy will be selected. In some cases, observation on the user leads to conflicts between the observation and the taken stereotype assumption which are settled by selecting the observed characteristics. Other alternatives are determining a necessity level for each characteristic or introducing a question to the user.

Looking again at FIG. 2A, the next step 22 is to load the stored information about the user task and function/position. The interface will handle differently users from different positions, even for executing the same task For example, in case when two different users, a software engineer and a secretary have the same task, like composing a letter, the interface will interact with them differently, based on the assumption that the level of knowledge of the software engineer is much higher than the level of knowledge of the secretary.

After defining the user model and loading the user tasks, the system is ready for the next step 23, in which the first adaptation to the user is implemented. A flowchart of the first adaptation is shown in FIG. 2C. At the first step 206, the first user model is built. Accordingly, in the next step 207, an interface type which matches the specific user model and user tasks is loaded. Each user model emphasizes different attributes such as font size, density of displayed information, preferred mode of interaction (e.g., voice, editing, printing, soft touching etc.) as well as tasks. For instance, if the user age is over 60, interaction may require large icons, (relatively) few options displayed, easy communication, simple tasks, a soft touch screen etc.

In the next step 24, the interface expects the user to interact with the system. If after a predetermined period of time T, there is no reaction from the user the system assumes that the user is facing a difficulty and then the next step 25 a smart (intelligent) help is offered to the user. FIG. 2B shows the content of smart help. In step 205, the system guides the user according to the current user model and level of adaptation which corresponds to the current user model The level and kind of help is determined according to the preliminary user model. At this point, the intelligent interface starts to collect more information about the user by monitoring his operations. The reaction time of the user is measured and stored in the database and will be used later to update the user model.

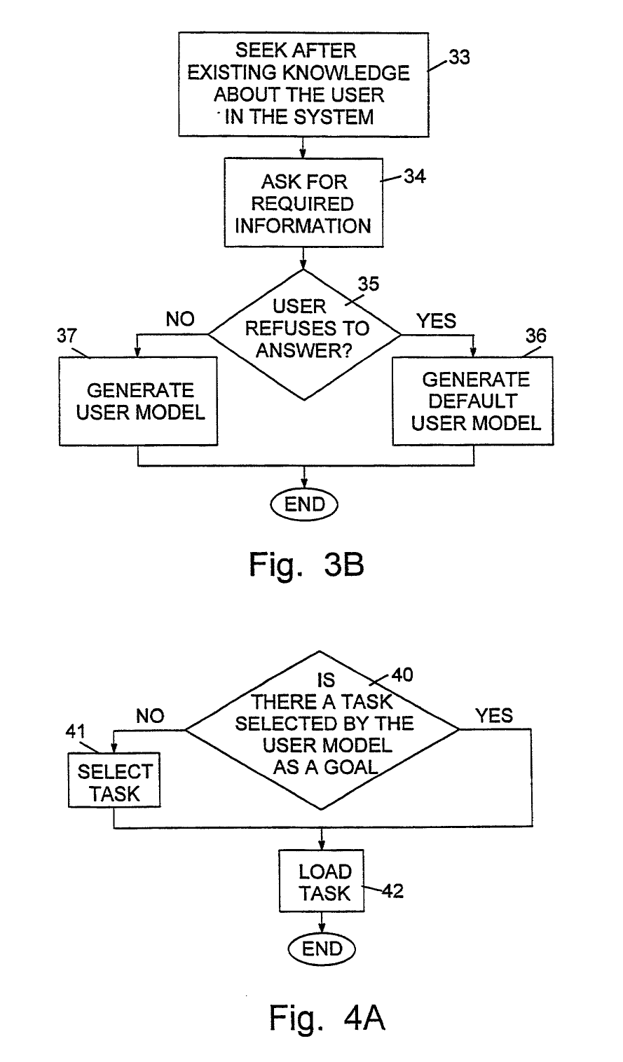

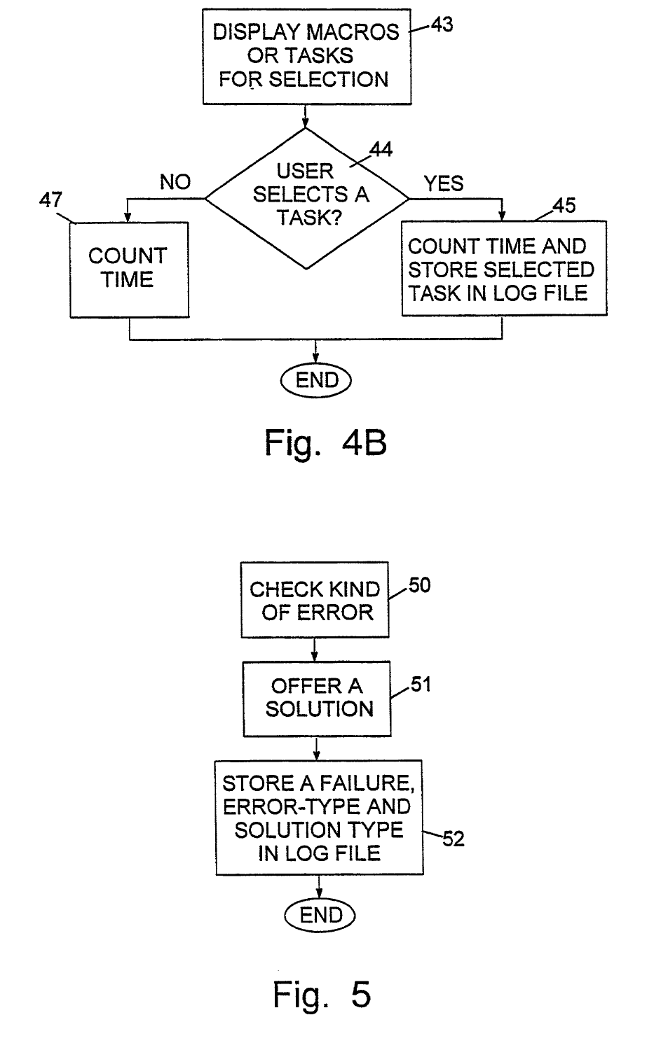

A flow chart of an intelligent help process is illustrated in FIG. 4A. At the first step 40 the interface checks if there is an existing task which is selected as a goal by the user. If not, the next step 41 is to offer the user to select one. If there is a task which is a user goal, the next step 42 is to load this task.

FIG. 4B is a flow chart of task selection. At the first step 43, a list of tasks and/or macros is displayed to the user for selection. In the next step 44, the system checks if the user has selected a task. If not, the time with no task selection is counted at step 47, for a case when the user needs help. If a task is selected, the selected task, as well as the time lapsed until the selection of this task, are stored in the current session log file, at step 45.

The time lapses may indicate that some of the user tasks are his main tasks within the session, since they occupy a major portion of his time. Both time counts indications about the user preferences, as well as competence and/or experience, and used later to update the user model.

As an example for intelligent help, if the user reacts after few seconds the system classifies him as a user with high level of knowledge. On the other hand, if even after help is offered the user still does not react, the system may offer him more intensive help or even provide him instructions how to proceed.

At the next step 26 of FIG. 2A, a request for operation is received from the user and stored in a user protocol for the user reactions. This information about requests from the user is also exploited later to update the user model. For example, if the user requested an advanced function of the operated software, this may indicate on high level of knowledge. FIG. 2E is a flow chart of receiving a request from the user. In the first step 209, the system checks if any request (from the user) is received. If yes, at step 213, the request is stored in the current session log file. If no, at step 210, the system checks if the user wishes to terminate the current session. In case when the user wishes to terminate the current session, by pushing the “Esc” (escape) button, the request is set to “go to end” in step 211. In case when the user wishes to continue, the system displays instructions for the user, according to step 212.

At the next step 27, the system checks if the request from the user is correct from the aspect of the operated software. If the request is correct, the next step 29 is execution of the request. If the request is incorrect, step 28 is provides corrective instructions to the user, and going back to step 26. According to step 208, shown in FIG. 2D, the request from the user is executed and a success is stored in the current session log file, for further adaptation.

A flow chart of guiding the user is illustrated in FIG. 5. At the first step 50 the interface checks the kind of error resulted from the user request. The next step 51 is to offer a corrective operation (solution) to the user. In the next step 52, information about the error type, solution type is stored in the log file of the current session, as well as the occurrence of the error.

In both cases, the number of successes (correct requests) and failures (incorrect requests) is stored is the user protocol, as well as the kind of corrective instructions provided to the user. This information is used to update the user model. After execution of the first request of the user, if after checking the kind of the request at step 201, the request is different than “go to end”, the next request from the user is received and steps 26 to 29 of FIG. 2A are repeated iteratively, until all requested tasks are executed, where at each iteration more information about the user is collected.

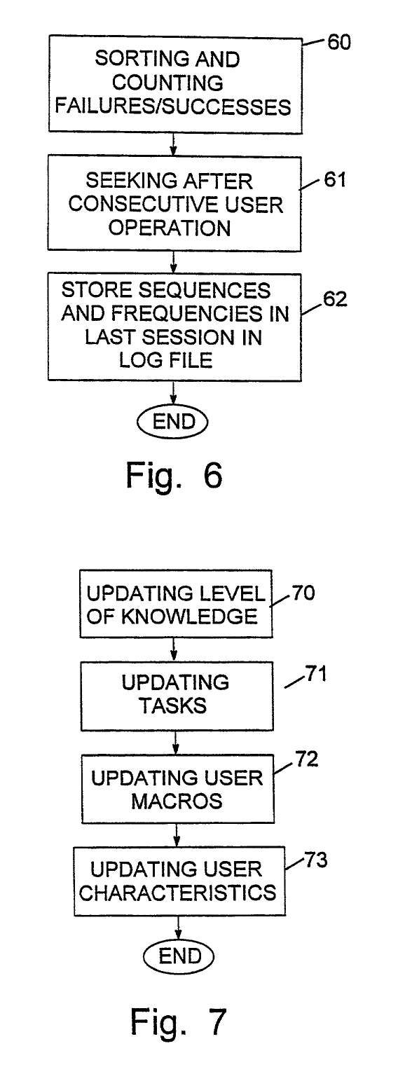

At the next step 202, the interface automatically processes the user protocol to extract the required inferences about the user. A flow chart of processing of the user protocol is illustrated in FIG. 6. At the first step 60 successes as well as failures are sorted and counted. Consecutive user operations are sought at the next step 61 so as to identify potential macros. In the next step 62, identified sequences and their corresponding frequencies during the current session are stored in the session log file.

Sequences of typical user operations are sought in the next step 202 of FIG. 2A. Identified sequences are sorted and their frequency is counted. A user macro is generated automatically in any case when the frequency of a sequence is higher than a predetermined value.

This processed information is used to update the user macros. For example, if the user interacts with a word processor, and the user has some typical preferences like having red header with bold and italic fonts comprising his name and date while typing letters, a macro that sets these kind of header is generated and operated automatically every time the user operates the word processor. This macro is updated according to the user operation at the next time he operates the same word processor.

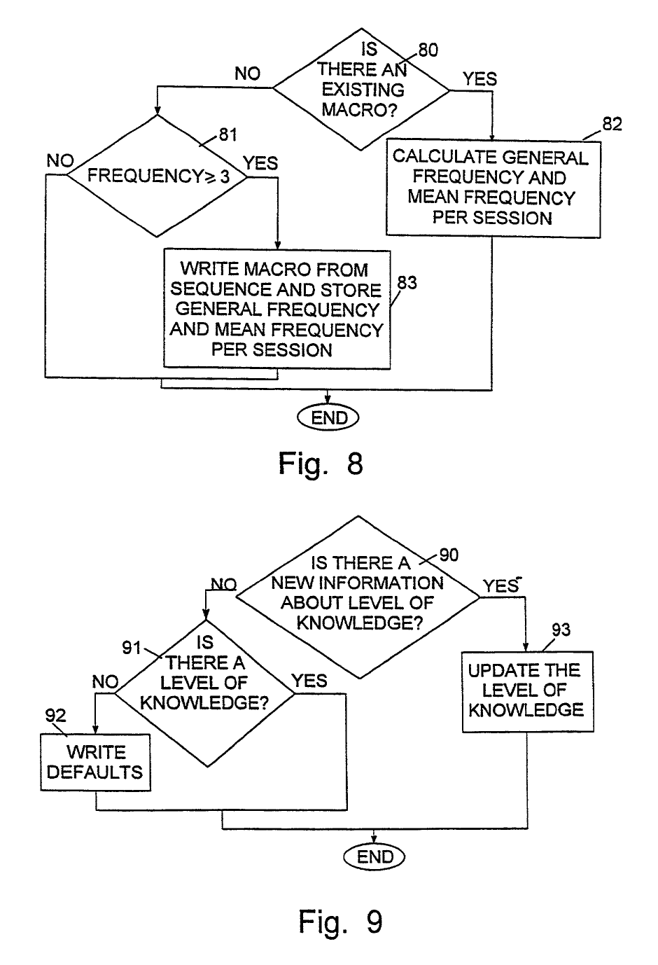

FIG. 8 is a flowchart of updating process of the user macros. The first step 80, is to seek after an existing macro. If there is an existing macro, the mean frequency of that macro during the current session, as well as the general frequency for all past sessions, are calculated at step 82 and stored in the database. If no macro is identified, the frequency of each sequence is measured at step 81. If this frequency is less than three (or any other predetermined value) times per session, no macro is generated. If the this frequency is over than three (or any other predetermined value) times per session, a macro is generated for that sequence at step 83. The mean frequency of the new macro during the current session, as well as the general frequency for all past sessions, are calculated and stored in the database.

The final step 203, in the flowchart of FIG. 2A is updating the preliminary user model according to the information collected at the protocol during his operation. This updated user model is employed during the next interaction with the user. FIG. 7 is a flowchart of the updating process of the user model. At the first step 70 the user's level of knowledge is updated according to the processed information from the user protocol. At the next step 71 the user tasks are updated according to the frequency of each kind of user task. If no task exists, the next task is added. The user's modes of operation stored and processed in the user protocol is updated at the next step 72. The final step 73 is updating the user characteristics in case of a conflict or when a new characteristic is disclosed after processing the user protocol.

FIG. 9 is a flowchart of updating of the user's level of knowledge. At the first step 90, the interface checks there is a new information about the level of knowledge. If not, the next step is to check if there is any level of knowledge related to the user. If not, a default value is inserted at the next step 92. If there is a new information from step 90, the next step 93 is to update the level of knowledge.

FIG. 10 is a flow chart of task updating. For every task recorded in the current session log file, the system checks, at step 110, if there are existing tasks. These tasks may be system tasks (saving, printing etc.) which are not included within the user model, or a utility in a new software (for instance, labels in Microsoft Word). If not, the frequency of each task is calculated, and the task is analyzed in step 103, looking after regular patterns which are important for starting. These patterns may be, for instance, reading E-mail in the beginning or in the end of each session, or background tasks, like looking after specific information in the Internet, on line E-mail or optimization, which continue to run in parallel with (other) current user tasks.

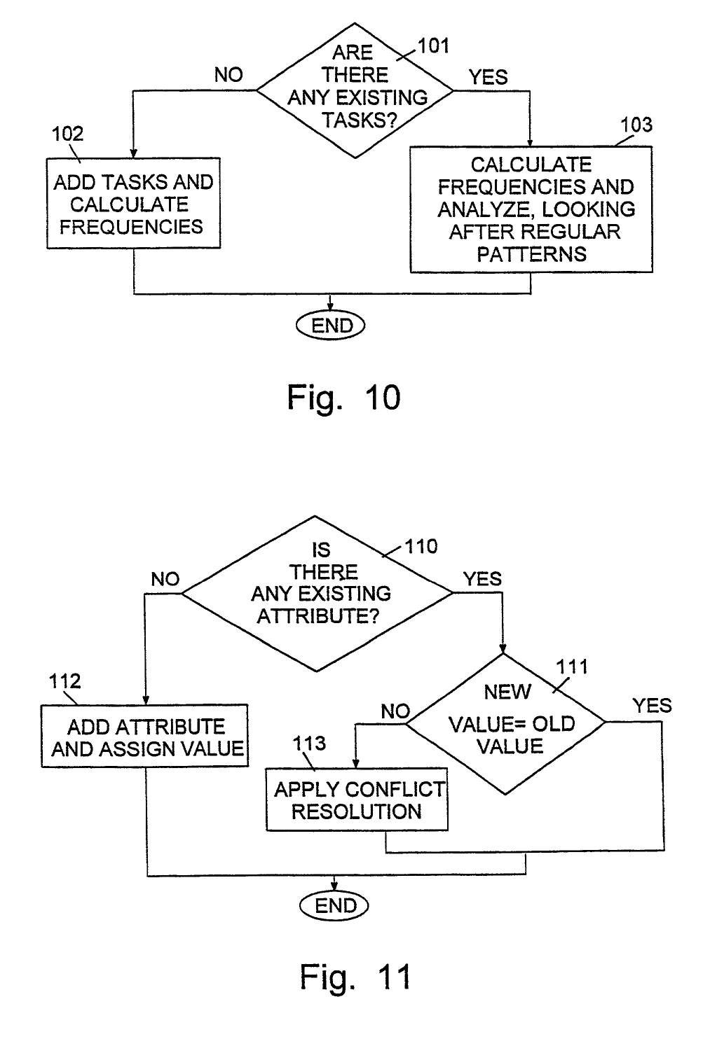

FIG. 11 is a flowchart of updating the user characteristics. In the first step 110, for every attribute recorded in the session log file, the system checks is there any existing attribute in the database of the user model. If no, at step 112, an attribute is added and a corresponding value is assigned to the associated user characteristic. If yes, at the next step 111, the system checks if the new value of the characteristic equals the old value. If yes, there is no conflict. If no, this is an indication of a conflict (contradiction), between user characteristics, and conflict resolution is applied at step 113, in which the value of the characteristic with the lowing hierarchical level is selected, or values are assigned according to the level of certainty for each characteristic, or values are selected according to observations, or defining necessity level for each characteristic.

According to the invention, task modeling is required in addition to user modeling. Task modeling represents operations that should be carried out by the user to achieve his goals. A task modeling system collects inputs from three information sources: the customer, the user(s) and the designer of the computerized system. The customer (e.g., a managing director in an organization) provides inputs (e.g., answering a questionnaire) about the users, their needs, jobs, positions and their perception of using the computerized system, which are then used by the designer. The users provide inputs about their goals, preferences and needs required for functioning. The system designer provides inputs which are based on inputs from the customer and the user together with his experience in task analysis and definition.

The task modeling system provides the dialog manager two kinds of outputs: individual tasks, each comprising operations and sub-tasks that construct the task, and definition of each user position which is represented by the collection of all tasks executed by an individual user. Task analysis (or decomposition) is carried out by the system according to a pre-programmed method selected by the system designer. According to the present invention, Hierarchical Task Analysis (HTA), is used. HTA is an iterative process where each task may be decomposed to sub-tasks and so fourth until one of a set of predetermining basic operations is reached. HTA is easy to understand both to the user and to the system designer and may be presented graphically or verbally.

According to a preferred embodiment of the invention the specific sequence of tasks and/or sub-tasks is defined, including their attributes. These attributes may comprise the timing of carrying out the task/sub-task, a manual or a computer oriented task/sub-task, or any combination of them, and the control structure of the task/sub-task. The control structure defines if the task is carried out serially, or in parallel or iteratively, or if the execution of the task is conditioned.

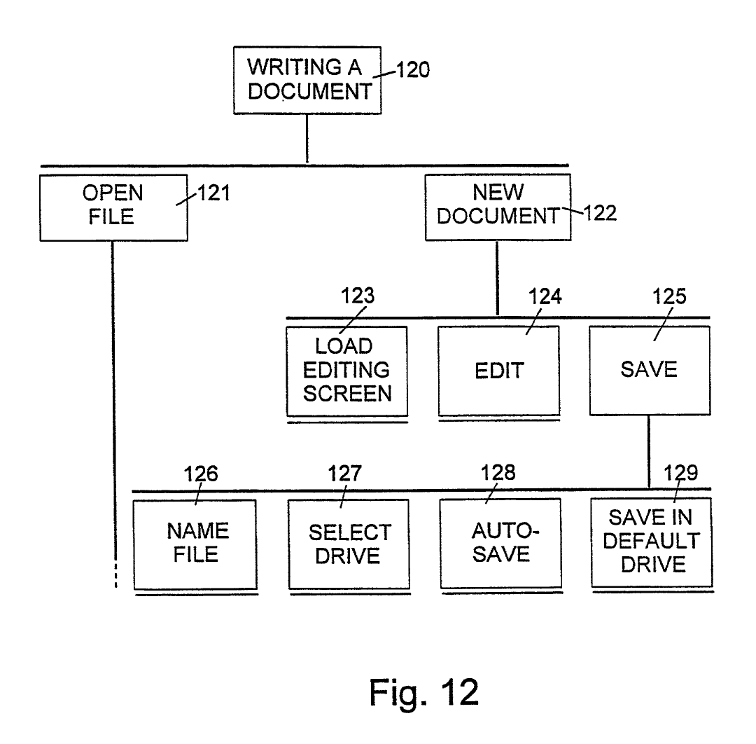

An example of HTA is illustrated in FIG. 12. In this example, the task is writing a document using a word processor. The main task 120 is divided to two tasks: open an existing file 101 and begin a new file 122. Task 122 is divided to three secondary tasks: load editing screen 123, edit 124 and save 125. The save task 125 is divided to four sub-tasks: name the file 126, select drive for file saving 127, auto-save 128 and save the file in the default drive 129. In a similar way, task 121 may also be divided to sub-tasks and then to basic operations. Other (known) methods of task analysis may also be used by the present invention.

After modeling the user by the stereotype user model and the task by task analysis the dialog manager operates an adaptation process to the user model which is derived from the user model according to his competence and level of knowledge in different relevant subjects. Several adaptation levels like maintenance, modifying defaults, monitoring the user operations, settling conflicts and updating the user model may exist. The user model is updated by modifying current values of existing characteristics and/or adding new characteristics.

For example, if the user is a 5 years old child who likes to operate a drawing software running on a PC, an initial adaptation level is determined according to the user model, based on the assumption that a 5 years old child does not read and write, is not able to operate a keyboard and may have difficulties with small details on the display. As a result, before loading the software the screen displays large icons, the background is taken from a cartoon film, instructions/help are given vocally and requests from the user are received by soft touching icons on the display. Further adaptation which is responsive to observations on the child is activated during operation.

As an illustrative example a Microsoft Windows environment was selected, comprising three demonstrations of the user modeling, the task modeling and adaptation to the user model.

### Example 1—User Modeling

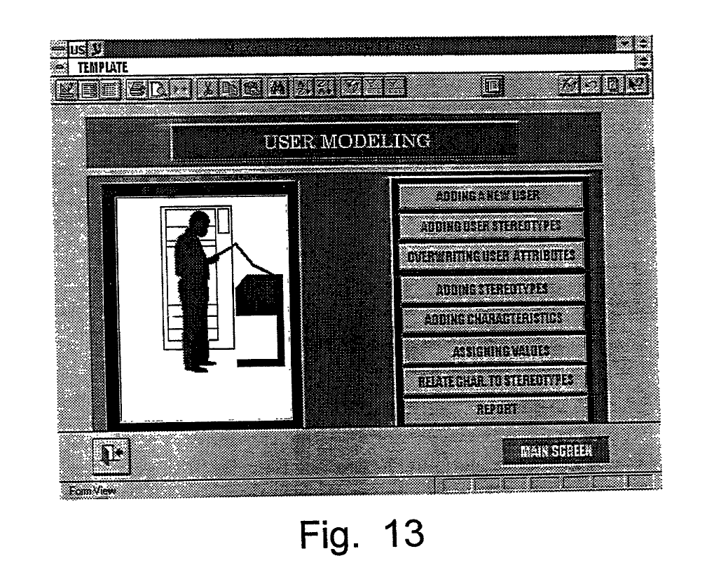

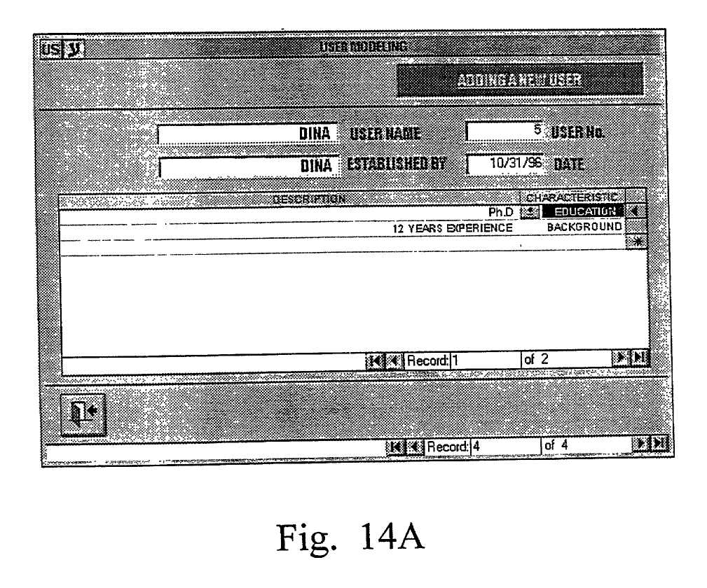

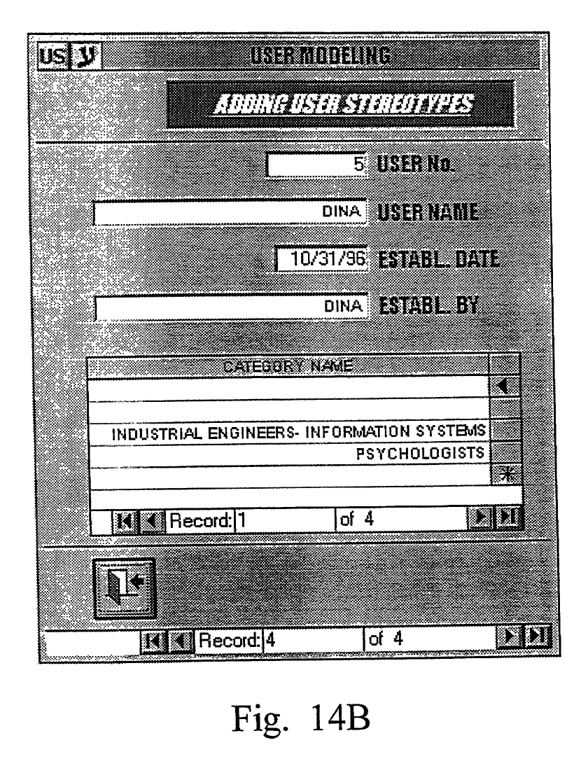

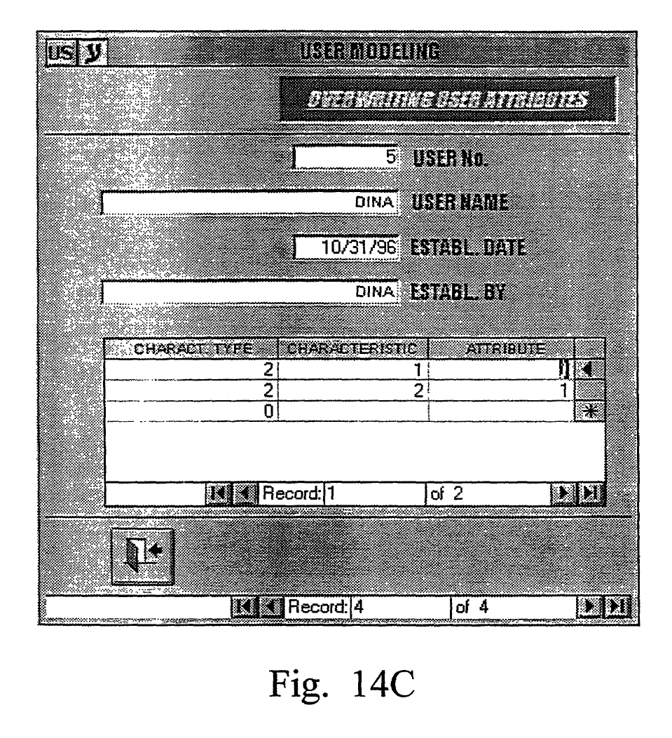

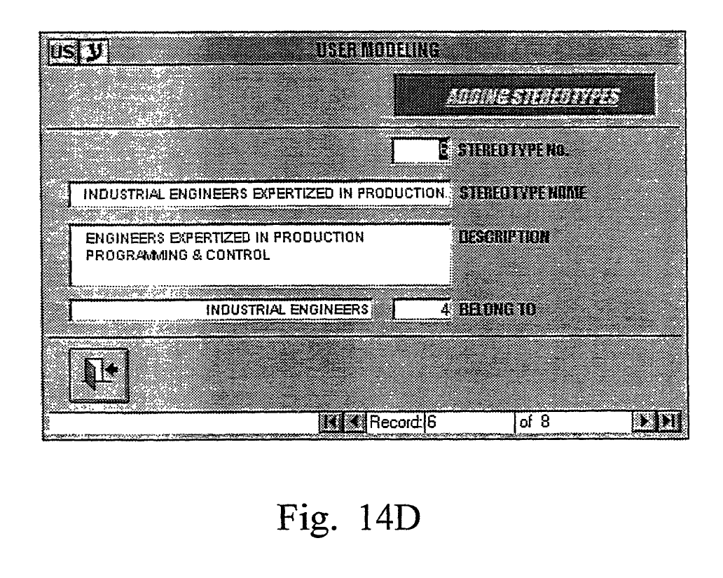

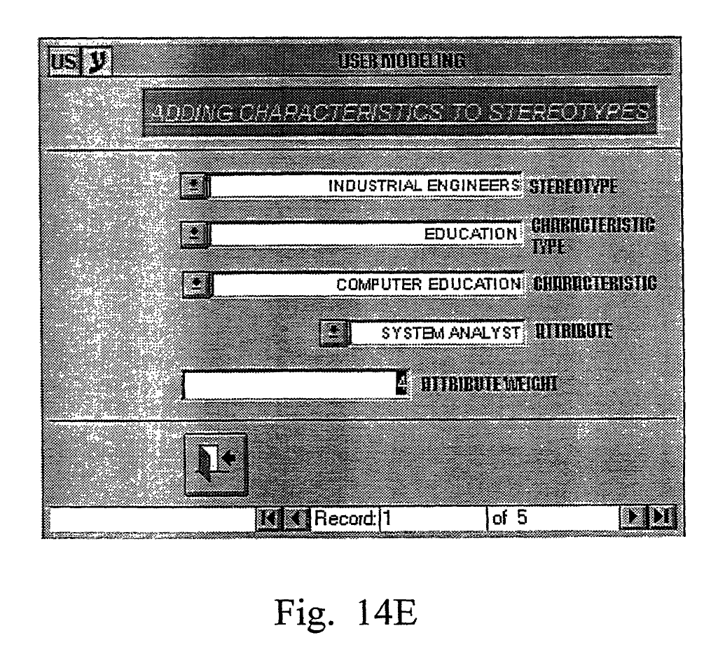

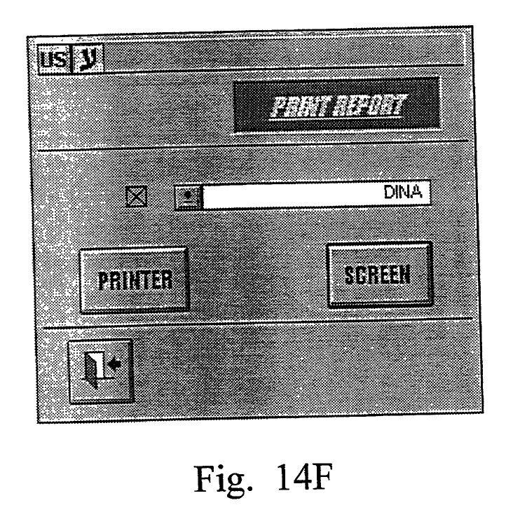

The user model is implemented using Microsoft Access. Implementation of the user modeling is carried out by the main screen, as shown in FIG. 13. Basically, the basic information about the user may be inserted by the system customer and the user model is built accordingly, being updated during operation. The first function in the main screen is establishment of a specific user, as shown in the screen of FIG. 14A. Basic user details like user name, user number, date of establishment and comments about the user in accordance with different categories (e.g., education and prior interaction with computers).

The second function in the main screen is relating categories to the user, as shown in the screen of FIG. 14B. The user is associated with different stereotypes (e.g., engineers, industrial engineers, industrial engineers specialized in information systems and psychologists).

The input from the system customer may be skipped, and interaction with the user may begin (as explained before) even without any details about the user. Instead, user selected default values are loaded.

In the fourth function, different user stereotype categories are defined, as shown in the screen of FIG. 14D. Basically, these stereotype categories are constructed in hierarchical form (e.g., successors and predecessors).

After loading all the stereotypes related to the user, and/or after interaction with the user, the extracted information may cause a conflict. Different attributes may be assigned to the same characteristics by different stereotypes. The third function in the main screen, enables to overwrite attributes for each characteristic representing the user, which are used as absolute values, as shown in the screen of FIG. 14C. Different user categories are defined with associated values. In the sixth function, each user category is associated with different characteristics (e.g., associating education period and level of computer education with the category of industrial engineers) by weighted association, as shown in the screen of FIG. 14E. This weighted association is used in case of conflicts between observed data and the user model. The last function in the main screen is generating (or printing) a user report, as shown in the screen of FIG. 14F. This report is used for monitoring the user model in the interface.

### Example 2—Task Modeling

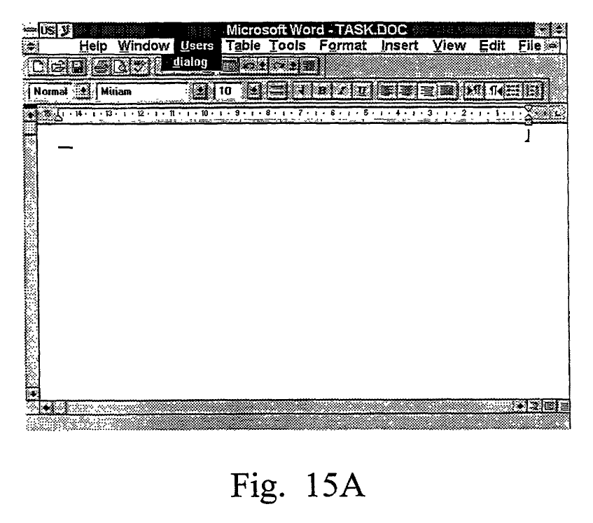

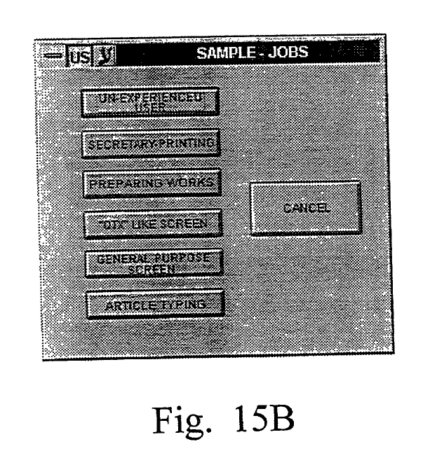

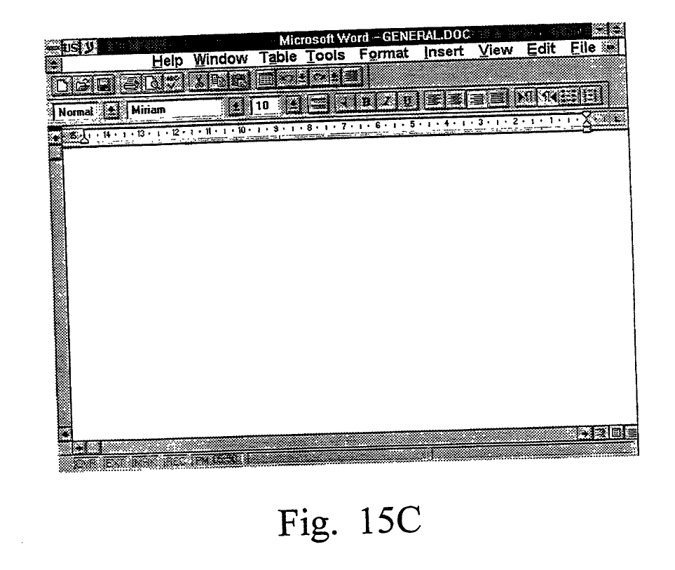

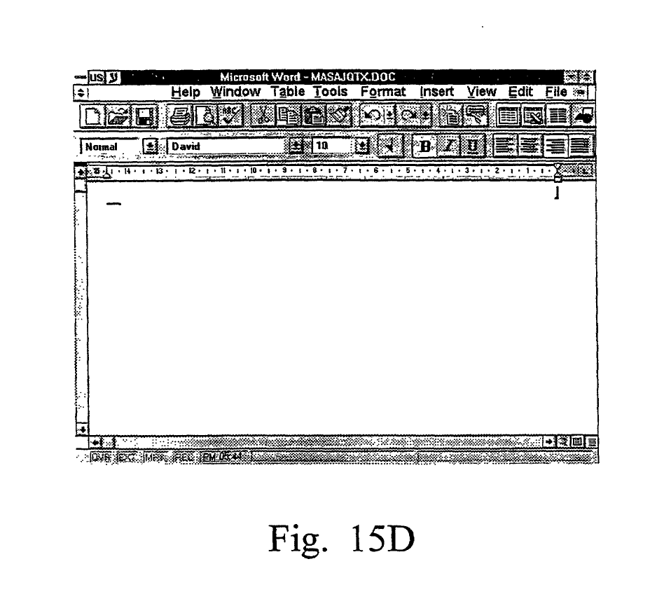

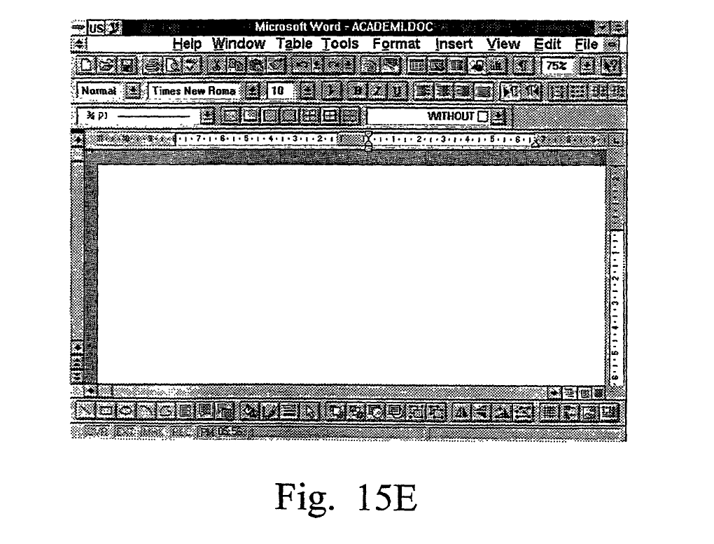

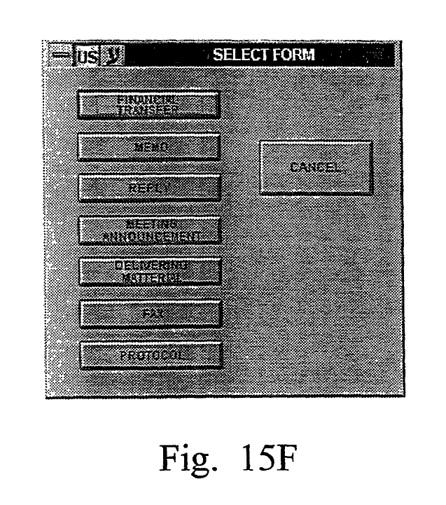

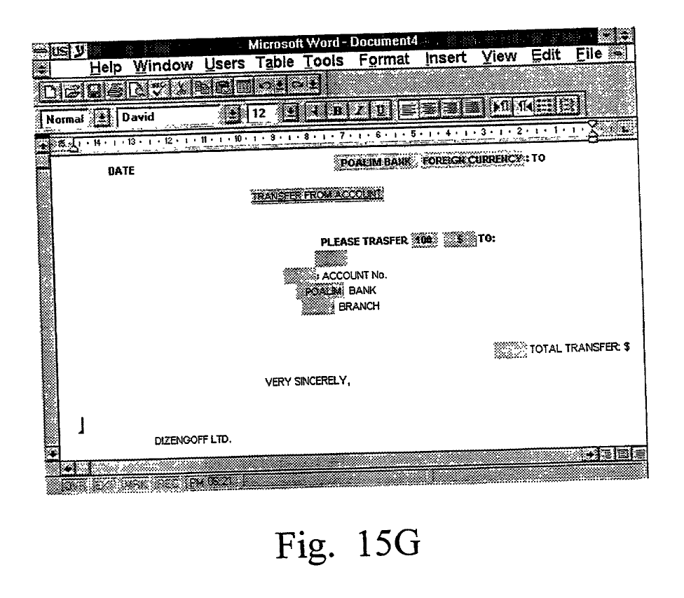

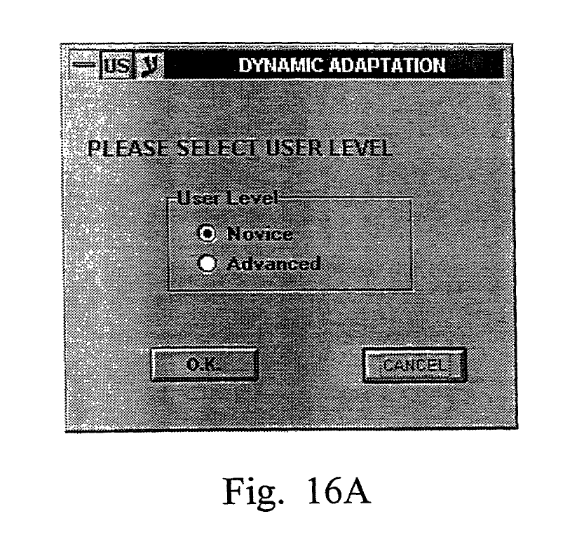

Microsoft Word 6.0 (word processor) is selected for demonstrating the process of task modeling. Several modification are implemented in Word for task definition. First, the default HNORMAL template is modified by adding “users” menu which comprises a “dialog” utility, as shown in the screen of FIG. 15A This modification enables all previous functions of Word together with additional functions. Since each category of users carries out its typical tasks which are defined in the template, different required styles as well as special tools for each task are defined and saved as *.dot files. In addition, each template is associated with specific help files in several levels, which are normal read only Word (*.doc) files which are opened by special icons from the tool bar or alternatively by from specific menus.

After selecting “dialog” utility from “users” menu, a specific screen for selection from several options is displayed, as shown in the screen of FIG. 15B. These options are related to tasks of an unexperienced user, a secretary and students. Other options like a screen with Qtext word processor (QTX) format, general purpose screen and article typing screen are available. Tool bars are adapted to the task according to collected information. For instance, a tool bar containing only the basic functions for editing and printing is displayed to an unexperienced user, as shown in the screen of FIG. 15C. Other users experienced in QTX who face difficulties with icon size may use a “QTX compatible” screen, shown in the FIG. 15D. Another screen, shown in FIG. 15E, is dedicated for preparing an academic article. This screen enables typing in two columns as well as inserting tables and graphical objects into the text.

The screen shown in FIG. 15F contains several tasks which are typical to a secretary (e.g., financial transfers, typing a memorandum, typing a fax cover sheet and typing a meeting protocol). Selecting a financial transfer option, for instance, leads to a dedicated screen for that task, as shown in FIG. 15G. All dedicated (selectable) formats are prepared in advance according to previous standards. There is also a possibility that the user creates a form and adds it to the screen for future use.

### Example 3—Adaptation of the Dialog Level

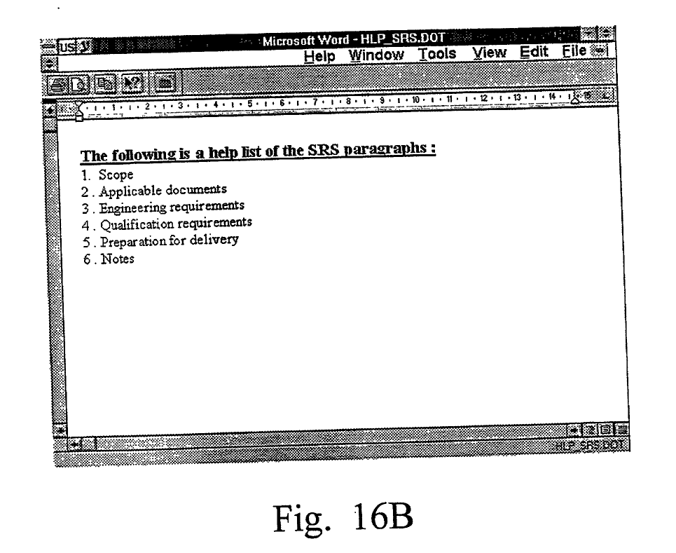

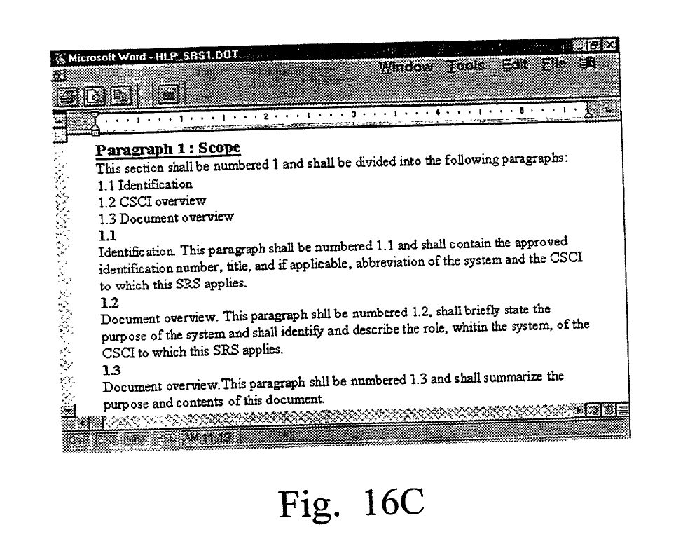

Adaptation to the user is expressed in this example by forming the screen as well as the format and content of the help program. After selecting the “startmenu” box, a screen which defines the level of user is displayed, as shown in FIG. 16A. The user may select the “novice” box or the “advanced” box. If “novice” box is selected, instead of a standard (and complicated for “novice”) Word toolbar, a screen with help toolbar comprising six help boxes (Scope, Applicable Documents, Engineering Requirements, Qualification Requirements, Preparation for Delivery and Notes) about different subject is displayed, as shown in FIG. 16B. These six subjects represent the subjects used for composing a Software Requirement Specifications (SRS) document involved in software development projects. By selecting the “Scope” box, for instance, an extended help screen is displayed to a user with no experience in preparing SRS documents, as shown in FIG. 16C.

Another advanced help subjects are introduced to an advanced user by selecting the “advanced” box. When an advanced user is operating the software, the advanced help box disappears after the third time help is requested during the same session. In this manner, a dynamic adaptation to the user level of knowledge is implemented, based on the assumption that after a determined number (three in this case) of times a direct access to advanced help is no more necessary. Of course, if the user likes to continue with the advanced help, he may select the subject box again and have the same direct access to advanced help for three more times during the session.

Of course, the above examples and description has been provided only for the purpose of illustrations, and are not intended to limit the invention in any way. The present invention is not restricted to Windows environment, and may be carried out in different environment of different data bases, such as relational, object oriented and others. As will be appreciated by the skilled person, the invention can be carried out in a great variety of ways, employing more than one technique from those described above, all without exceeding the scope of the invention.

1. Method for interactive, user adaptive operation of a computerized system by using an intelligent user interface, comprising the steps of:
a) collecting and storing information about the user;
b) collecting and storing information about the user task;
c) building a preliminary dynamic stereotype user model based on predetermined default values and/or on the information about the user;
d) building a task model for the user;
e) determining and providing a preliminary adaptation level of the interface to the user;
f) characterizing the user task by adaptation between the user task and the user;
g) offering the user assistance after a predetermined period with no user operation;
h) receiving requests from the user and executing them by operating an adaptive dialog manager for the specific user, in case of correct requests indicating the kind and number of user successes;
i) receiving a request from the user and providing the user instructions/help by operating an adaptive dialog manager for the specific user, in case of incorrect requests indicating the kind and number of user failures;
j) generating and/or processing a user protocol representing the information about the user collected during his operation;
k) generating and/or updating macros and/or batch automated files representing the user's modes of operation by a sequence of operations typical for the user;
l) updating the preliminary user model, the user tasks and the user characteristics in a manner responsive to the processed information from the user protocol and to successes/failures during operation of the user observed by the dialog manager;
m) updating the user characteristics in case of occurrence of a conflict between characteristics resulting from the collected information the stereotype user model;
n) modifying the preliminary adaptation level of the dialog manager; and
o) interacting with the user through the dialog manager according to the updated user model, user tasks and user characteristics.

2. Method according to claim 1, wherein information about the user preferences is collected by monitoring the user operations.

3. Method according to claim 2, wherein the number of times the user requested for help being counted.

4. Method according to claim 2, wherein the number of user errors during operation being counted and interpreted.

5. Method according to claim 2, wherein time intervals between consecutive user operations being measured.

6. Method according to claim 2, wherein the user preferences are monitored during operation.

7. Method according to claim 1, wherein information about the user is collected by first introducing a questionnaire to the user.

8. Method according to claim 1, wherein information about the user is collected from a preliminary interview with the user.

9. Method according to claim 1, wherein default values are extracted from pre-programmed assumptions.

10. Method according to claim 1, wherein default values are extracted from researches on the addressed population of users.

11. Method according to claim 1, wherein default values are extracted from studies of the addressed population of users.

12. Method according to claim 1, wherein the user model is constructed by the steps of:
a) defining hierarchy of user stereotypes representing different user classifications;
b) associating objective and/or subjective characteristics for each user stereotype;
c) assigning a value for each characteristic;
d) representing the connection between the user classification and the user stereotype by a corresponding value from a predetermined scale;
e) characterizing the user preliminary model by selecting a set of stereotype attributes; and
f) updating the preliminary characterization by modifying/adding user characteristics and/or their values based on observation.

13. Method according to claim 12, wherein the user is further characterized by settling contradictions between user characteristics by the steps of:
a) obtaining all the user direct/indirect relations to different user stereotypes;
b) obtaining all the user direct/indirect relations to different characteristics existing in the stereotypes to which the user being related;
c) obtaining all the user certain characteristics based on observation; and
d) for each user characteristic with more than one value, selecting only the highest value and its associated stereotype.

14. Method according to claim 1, wherein the task model is constructed by the steps of:
a) collecting and storing information about the user tasks from the customer, the user and the system designer;
b) collecting and storing information about the user needs from the customer, the user and the system designer;
c) collecting and storing information about the user functions from the customer, the user and the system designer;
d) interacting with the utilities of the inherent operating system in a manner enabling execution of these utilities by the interface;
e) determining the lowest task level;
f) decomposing each task to a set of sub-tasks necessary to accomplish the task;
g) decomposing each sub-task iteratively, until the lowest task level is reached;
h) defining the specific sequence of tasks and/or sub-tasks; and
i) outputting a set of individual tasks and/or jobs representing several tasks, into the dialog manager.

15. Method according to claim 14, further comprising determining the attributes of the tasks and/or sub-tasks.

16. Method according to claim 15, wherein the attributes of the tasks and/or sub-tasks are selected from the following group of attributes:
the timing of carrying out the task/sub-task;
a manual or a computer oriented task/sub-task, or any combination thereof; and
the control structure of said task/sub-task.

17. Method according to claim 15, wherein the control structure of the tasks and/or sub-tasks is selected from the following group of control structures:
a serial structure;
a parallel structure;
an iterative structure; and
a conditioned structure.

18. Method according to claim 14, wherein the inherent operating system comprises editing utilities.

19. Method according to claim 14, wherein the inherent operating system comprises printing utilities.

20. Method according to claim 14, wherein the inherent operating system comprises reading utilities.

21. Method according to claim 14, wherein the inherent operating system comprises connecting utilities to other networks.

22. Method according to claim 21, wherein each other network is selected from the following group of networks:
a computer network;
a web-based network;
a telephone network;
a cellular network; and
a cable TV network.

23. Method according to claim 1, wherein the system provides the user help in case when no task is selected for execution.

24. Method according to claim 1, wherein the system analyzes the type of failure during the user operation and provides the user corrective instructions.

25. Method according to claim 1, wherein the user protocol is processed by the steps of:
a) for each task, counting and sorting the number of user correct operations;
b) for each task, counting and sorting the number of user failures; and
c) seeking after user macros during operation and counting the frequency of each macro.

26. Method according to claim 1, wherein the user model is updated by the steps of:
a) updating the user level of knowledge;
b) updating the user tasks;
c) updating the user macros; and
d) updating the user characteristics.

27. Method according to claim 21, wherein the user level of knowledge is updated by the steps of:
a) seeking after new information about the level of knowledge;
b) updating the current level of knowledge in case when new information is identified,
c) using the current level of knowledge in case when no new information is identified and a level of knowledge exists; or
d) using default parameters as the current level of knowledge in case when no new information is identified and no level of knowledge exists.

28. Method according to claim 26, wherein each user task is updated by adding a task in case when no task exists.

29. Method according to claim 26, wherein each user macro is updated by the steps of
a) seeking after an existing macro;
b) calculating the mean frequency per session and the general frequency of all previous sessions, in case when an existing macro is identified;
c) counting the frequency of any identified sequence of user operations, in case when no existing macro is identified;
d) generating a macro from the identified sequence, in case when no existing macro is identified and the frequency of step c) above is equal to or higher than a predetermined value; and
e) for each generated macro, storing the mean frequency per session and the mean frequency of previous sessions.

30. Method according to claim 26, wherein each user characteristic is updated by settling contradictions between user characteristics.

31. Method according to claim 1, wherein interaction between the user and the dialog manager is carried out by a keyboard with suitable display.

32. Method according to claim 1, wherein interaction between the user and the dialog manager is carried out by soft touch sensors with suitable display.

33. Method according to claim 1, wherein interaction between the user and the dialog manager is carried out by a microphone and a speaker with suitable display.

34. Method according to claim 1, wherein interaction between the user and the dialog manager is carried out by a suitable means, selected from the following group:
a soft touch display;
PDA;
TV remote control unit;
cellular telephone; and
interactive TV.

35. Method according to any one of claims 1 to 34, wherein the computerized system is a PC.

36. Method according to any one of claims 1 to 34, wherein the computerized system is a workstation.

37. Method according to any one of claims 1 to 34, wherein the computerized system is a mini-computer.

38. Method according to any one of claims 1 to 34, wherein the computerized system is a main-frame computer.

39. Method according to any one of claims 1 to 34, wherein the computerized system is a client-server system.

40. Method according to any one of claims 1 to 34, wherein the computerized system is an INTERNET server.

41. Method according to any one of claims 1 to 34, wherein the computerized system is a telemedicine network.

42. A computerized system comprising:
a) computer hardware and peripheral devices;
b) an operating system software for running user applications;
c) a user application software running by the operating system; and
d) an intelligent user adaptive interface for interaction between the user and the operating system and/or application software.

43. An intelligent user adaptive interface according to claim 42, comprising:
a) means for collecting and storing information about the user;
b) means for collecting and storing information about the user task;
c) means for building a preliminary dynamic stereotype user model based on predetermined default values and/or on the information about the user;
d) means for building a task model for the user;
e) means for determining and providing a preliminary adaptation level of the interface to the user;
f) means for characterizing the user task by adaptation between the user task and the user;
g) means for offering the user assistance;
h) means for receiving requests from the user and executing them by operating an adaptive dialog manager for the specific user;
i) means for generating and/or processing a user protocol representing the information about the user collected during his operation;
j) means for generating and/or updating macros and/or batch automated files representing the user's modes of operation;
k) means for updating the preliminary user model, the user tasks and the user characteristics in a manner responsive to the processed information from the user protocol and to successes/failures during operation of the user observed by the dialog manager;
l) means for updating the user characteristics in case of occurrence of a conflict between characteristics resulting from the collected information the stereotype user model;
m) means for modifying the preliminary adaptation level of the dialog manager; and
n) means for interacting with the user trough the dialog manager according to the updated user model, user tasks and user characteristics.

44. An intelligent user adaptive interface according to claim 43, comprising means for monitoring the user operations.

45. An intelligent user adaptive interface according to claim 43, comprising means for counting and interpreting the number of times the user requested for help.

46. An intelligent user adaptive interface according to claim 43, comprising means for counting and interpreting the number of errors during user operation.

47. An intelligent user adaptive interface according to claim 43, comprising means for measuring the time intervals between consecutive user operations.

48. An intelligent user adaptive interface according to claim 43, comprising means for monitoring the, user preferences during operation.

49. An intelligent user adaptive interface according to claim 43, comprising means for providing the user help in case when no task is selected for execution.

50. An intelligent user adaptive interface according to claim 43, comprising means for analyzing the type of failure during the user operation and means for providing the user corrective instructions.

51. An intelligent user adaptive interface according to claim 43, where interaction with the user is carried out by a keyboard with suitable display.

52. An intelligent user adaptive interface according to claim 43, where interaction with the user is carried out by soft touch sensors with suitable display.

53. An intelligent user adaptive interface according to claim 43, where interaction with the user is carried out by a microphone and a speaker with suitable display.

54. An intelligent user adaptive interface according to claim 43, where interaction with the user is carried out by a suitable soft touch display.

55. An intelligent user adaptive interface according to claim 54, in which interaction between the user and the dialog manager is carried out by a suitable means, selected from the following group:
a soft touch display;
a TV set;
PDA,
TV remote control unit;
cellular telephone; and
interactive TV.

56. Method for interactive, user adaptive operation of a computerized system by using an intelligent user interface, substantially as described and illustrated.

57. A computerized system, operated by interacting with an intelligent, user adaptive interface, substantially as described and illustrated.
